(19) United States
(12) Patent Application Publication
(10) Pub. No.: US 2013/0063392 A1
(43) Pub. Date: Mar. 14, 2013

(54) METHODS FOR IDENTIFYING DOUBLE CLICKING, SINGLE CLICKING AND DRAGGING INSTRUCTIONS IN TOUCH PANEL

(71) Applicants: Li Sheng LO, HSIN CHU COUNTY (TW); Hsien-Yao Li, Hsin Chu County (TW)

(72) Inventors: Li Sheng LO, HSIN CHU COUNTY (TW); Hsien-Yao Li, Hsin Chu County (TW)

(21) Appl. No.: 13/495,923

(22) Filed: Jun. 13, 2012

(30) Foreign Application Priority Data
Sep. 9, 2011 (TW) 100132608

(51) Int. Cl. G06F 3/044; G06F 3/041

(52) U.S. Cl. 345/174; 345/173

(57) ABSTRACT

The present invention relates to methods for identifying a double-clicking instruction, a single clicking instruction and a dragging instruction in a touch panel. The method adds a determination step based on the distance between the touch panel and the object, such as finger to serve as a condition. The method can detect whether the finger is being close to the touch panel so that the pre-determination can be performed. The finger movement speed is used for further determination. If the finger movement speed is too slow, the operation would be served as failed operation.

This application claims priority of No. 100132608 filed in Taiwan R.O.C. on Sep. 9, 2011 under 35 USC 119, the entire content of which is hereby incorporated by reference.

### BACKGROUND OF THE INVENTION

1. Field of Invention

The invention relates to a technology of a touch panel, and more particularly to methods for identifying double clicking, single clicking and dragging instructions in touch panel.

2. Related Art

Touch panel is a device disposed on the liquid crystal display or on a laptop, whose function is for user to control the functionalities on the panel by touching the corresponding area, such that the data transfer is fulfilled or the message can be shown on the screen. The touch panel is widely used, including:

(1) Portable electronic, consumer and communication products: such as PDA, tablet PC, digital camera, Information appliances, 3G cell phone and so on.

(2) Financial or commercial use: such as ATM, purchase systems, remote video conference, telephone terminal system.

(3) Industrial uses: such as Factory automation control systems, central monitoring system, workstation.

(4) Public information purposes: such as Tour services of the air plane, train station, or shopping mall, information enquiry.

The sensing method of the touch panel includes steps of: outputting an analog signal when a finger touches the sensor; converting the analog signal to an acceptable digital signal for computer by a controller; compiling the digital signal through the touch panel driver and their relative elements; and displaying the touching position outputted by a video card through the display.

In the conventional computer operation, the most common operation includes three actions, which comprises signal click, double click and drag. Those operations are easy to recognize by a mouse. However, the misrecognitions for such three operations are usually happen on the touch panel. In order to solve the abovementioned problem, Synaptics provides a method for Identifying single clicking instruction, a method for identifying double clicking instruction and a method for identifying dragging instruction, as shown in FIG. 1. FIG. 1 illustrates the waveforms for single clicking instruction, double clicking instruction dragging according to the conventional art. Referring to FIG. 1, the determination of the single clicking instruction is as the waveform 101 shown in FIG. 1. If the time while a first contact to the touch panel occurs to the time while the end of the first contact to the touch panel occurs is smaller than a single click preset time T1, and there is no occurrence of other contact afterward, the touch control would be determined as a single clicking instruction.

The determination of the double clicking instruction is as the waveform 102 shown in FIG. 1. If the time, while a first contact to the touch panel occurs, to the time, while the end of the second contact to the touch panel occurs, is smaller than a double click preset time T2, the touch control would be determined as a double clicking instruction.

The determination of the dragging instruction is as the waveform 103 shown in FIG. 1. In the period from the time, while a first contact to the touch panel occurs, to the end of the double click preset time T2, there is no occurrence of the second contact to the touch panel, the touch control would be determined as a dragging instruction.

The abovementioned conventional method for determining double clicking, single clicking and dragging instructions in touch panel is suitable for the resistive touch panel and the temperature sensing panel (IR type) and the error would hardly occur in the conventional method when the resistive touch panel or the temperature sensing panel (IR type) is adopted. Because the sensing signal in the resistive touch panel or the temperature sensing panel (IR type) would change as long as an object touches the above-mentioned touch panel. Thus, the signal is only changed according to the contact and the departure of the finger or touch pen. However, when the touch panel is the capacitive touch panel, the sensing signal would be changed if the finger is close to the touch panel. Further, the sensing signal of the capacitive touch panel would be varied according to the size of the touching area of the finger. Thus, the abovementioned conventional method may not suitable for the capacitive touch panel.

### SUMMARY OF THE INVENTION

It is therefore an objective of the invention to provide a method for identifying a signal clicking instruction in a touch panel so that the signal clicking instruction can be distinct from the other instruction and the identifying error can be prevented.

Another objective of the invention is to provide a method for identifying a double clicking instruction in a touch panel so that the double clicking instruction can be distinct from the other instruction and the identifying error can be prevented.

Still another objective of the invention is to provide a method for identifying a dragging instruction in a touch panel so that the dragging instruction can be distinct from the other instruction and the identifying error can be prevented.

Still another objective of the invention is to provide a method for identifying instructions in a touch panel so that the single clicking, double clicking and dragging instructions can be distinct from the other instruction and the identifying error can be prevented.

To achieve the above-mentioned or other objectives, the invention provides a method for identifying a single clicking instruction, which is adapted for a touch panel. The method comprises the steps of: (1) outputting a sensing signal when an object touch the touch panel; (2) detecting a first transient time, wherein the first transient time is a period from the sensing signal being at an ending of a first state, which the touch panel does not be touched, to the sensing signal being at a beginning of a second state, which the touch panel is touched; (3) detecting a first sustained time, wherein the first sustained time is a period from the sensing signal being at the beginning of the second state in the step (2) to the sensing signal being at an ending of the second state; (4) detecting a second transient time, wherein the second transient time is a period from the sensing signal being at the ending of the second state, to the sensing signal being converted to the first state; (5) detecting a second sustained time, wherein the second sustained time is a period from the sensing signal being at a beginning of the first state in step (4) to the sensing signal being at a ending of the first state, wherein, when the second sustained time is longer than a determination time, the second sustained time is set to a determination time, wherein the first transient time is before the first sustained time, the first sustained time is before the second transient time, and the second transient time is before the second sustained time; (6) determining whether the first transient time is shorter than a first preset time, wherein a step (10) is performed when the first transient time is longer than the first preset time; (7) determining whether the first sustained time is shorter than a second preset time when the first transient time is shorter than a first preset time, wherein the step (10) is performed when the first sustained time is longer than the second preset time; (8) determining whether the second transient time is shorter than a third preset time when the first sustained time is shorter than the second preset time, wherein, when the second transient time is longer than the third preset time, the step (10) is performed; (9) determining whether the second sustained time is longer than a fourth preset time when the second transient time is shorter than the third preset time, wherein the step (10) is performed when the second sustained time is shorter than the fourth preset time; (10) outputting a false operation; and (11) determining a operation is the signal clicking instruction when the second sustained time is longer than the fourth preset time.

To achieve the above-mentioned or other objectives, the invention further provides a method for identifying a double clicking instruction, which is adapted for a touch panel. The method comprises the steps of: (1) determining whether an object touches the touch panel, wherein a sensing signal is outputted when the object touch the touch panel; (2) detecting a first transient time, wherein the first transient time is a period from the sensing signal being at an ending of a first state, which the touch panel does not be touched, to the sensing signal being at a beginning of a second state, which the touch panel is touched; (3) detecting a first sustained time, wherein the first sustained time is a period from the sensing signal being at the beginning of the second state in the step (2) to the sensing signal being at an ending of the second state; (4) detecting a second transient time, wherein the second transient time is a period from the sensing signal being at the ending of the second state in the step (3), to the sensing signal being converted to the first state; (5) detecting a second sustained time, wherein the second sustained time is a period from the sensing signal being at a beginning of the first state in step (4) to the sensing signal being at a ending of the first state, wherein, when the second sustained time is longer than a determination time, the second sustained time is set to a determination time; (6) detecting a third transient time, wherein the third transient time is a period from the sensing signal being at an ending of a first state in the step (5), to the sensing signal being at a beginning of a second state; (7) detecting a third sustained time, wherein the third sustained time is a period from the sensing signal being at the beginning of the second state in the step (6), to the sensing signal being at an ending of the second state; (8) detecting a fourth transient time, wherein the fourth transient time is a period from the sensing signal being at the ending of the second state in step (7) to the sensing signal being converted to the first state, wherein the first transient time is before the first sustained time, the first sustained time is before the second transient time, the second transient time is before the second sustained time, the second sustained time is before the third transient time, the third transient time is before the third sustained time, and the third sustained time is before the fourth transient time; (9) determining whether the first transient time is shorter than a first preset time, wherein a step (16) is performed when the first transient time is longer than the first preset time; (10) determining whether the first sustained time is shorter than a second preset time when the first transient time is shorter than a first preset time, wherein the step (16) is performed when the first sustained time is longer than the second preset time; (11) determining whether the second transient time is shorter than a third preset time when the first sustained time is shorter than the second preset time, wherein, when the second transient time is longer than the third preset time, the step (16) is performed; (12) determining whether the second sustained time is shorter than a fourth preset time when the second transient time is shorter than the third preset time, wherein the step (16) is performed when the second sustained time is longer than the fourth preset time; (13) determining whether the third transient time is shorter than a fifth preset time when the second sustained time is shorter than the fourth preset time, wherein, when the third transient time is longer than the fifth preset time, the step (16) is performed; (14) determining whether the third sustained time is shorter than a sixth preset time when the third transient time is shorter than the fifth preset time, wherein the step (16) is performed when the third sustained time is longer than the sixth preset time; (15) determining whether the fourth transient time is shorter than a seventh preset time when the third sustained time is shorter than the sixth preset time, wherein, when the fourth transient time is longer than the seventh preset time, the step (16) is performed; (16) outputting a false operation; and (17) determining an operation is the double clicking instruction when the fourth transient is shorter than the seventh preset time.

To achieve the above-mentioned or other objectives, the invention further provides a method for identifying a dragging instruction, which is adapted for a touch panel. The method comprises the steps of: (1) determining whether an object touches the touch panel, wherein a sensing signal is outputted when the object touch the touch panel; (2) detecting a first transient time, wherein the first transient time is a period from the sensing signal being at an ending of a first state, which the touch panel does not be touched, to the sensing signal being at a beginning of a second state, which the touch panel is touched; (3) detecting a first sustained time, wherein the first sustained time is a period from the sensing signal being at the beginning of the second state in the step (2) to the sensing signal being at an ending of the second state; (4) detecting a second transient time, wherein the second transient time is a period from the sensing signal being at the ending of the second state in the step (3), to the sensing signal being converted to the first state; (5) detecting a second sustained time, wherein the second sustained time is a period from the sensing signal being at a beginning of the first state in step (4) to the sensing signal being at a ending of the first state, wherein, when the second sustained time is longer than a determination time, the second sustained time is set to a determination time; (6) detecting a third transient time, wherein the third transient time is a period from the sensing signal being at an ending of a first state in the step (5), to the sensing signal being at a beginning of a second state; (7) detecting a third sustained time, wherein the third sustained time is a period from the sensing signal being at the beginning of the second state in the step (6), to the sensing signal being at an ending of the second state, wherein the first transient time is before the first sustained time, the first sustained time is before the second transient time, the second transient time is before the second sustained time, the second sustained time is before the third transient time, and the third transient time is before the third sustained time; (8) determining whether the first transient time is shorter than a first preset time, wherein a step (14) is performed when the first transient time is longer than the first preset time; (9) determining whether the first sustained time is shorter than a second preset time when the first transient time is shorter than a first preset time, wherein the step (14) is performed when the first sustained time is longer than the second preset time; (10) determining whether the second transient time is shorter than a third preset time when the first sustained time is shorter than the second preset time, wherein, when the second transient time is longer than the third preset time, the step (14) is performed; (11) determining whether the second sustained time is shorter than a fourth preset time when the second transient time is shorter than the third preset time, wherein the step (14) is performed when the second sustained time is longer than the fourth preset time; (12) determining whether the third transient time is shorter than a fifth preset time when the second sustained time is shorter than the fourth preset time, wherein, when the third transient time is longer than the fifth preset time, the step (14) is performed; (13) determining whether the third sustained time is longer than a sixth preset time when the third transient time is shorter than the fifth preset time, wherein the step (14) is performed when the third sustained time is shorter than the sixth preset time; (14) outputting a false operation; and (15) determining an operation is the dragging instruction when the third sustained time is longer than the sixth preset time.

To achieve the above-mentioned or other objectives, the invention further provides a method for identifying instructions, which is adapted for a touch panel. The method comprises the steps of: (1) determining whether an object touches the touch panel, wherein a sensing signal is outputted when the object touch the touch panel; (2) detecting a first transient time, wherein the first transient time is a period from the sensing signal being at an ending of a first state, which the touch panel does not be touched, to the sensing signal being at a beginning of a second state, which the touch panel is touched; (3) detecting a first sustained time, wherein the first sustained time is a period from the sensing signal being at the beginning of the second state in the step (2) to the sensing signal being at an ending of the second state; (4) detecting a second transient time, wherein the second transient time is a period from the sensing signal being at the ending of the second state in the step (3), to the sensing signal being converted to the first state; (5) detecting a second sustained time, wherein the second sustained time is a period from the sensing signal being at a beginning of the first state in step (4) to the sensing signal being at a ending of the first state, wherein, when the second sustained time is longer than a determination time, the second sustained time is set to a determination time, wherein the first transient time is before the first sustained time, the first sustained time is before the second transient time, and the second transient time is before the second sustained time; (6) determining whether the first transient time is shorter than a first preset time, wherein a step (18) is performed when the first transient time is longer than the first preset time; (7) determining whether the first sustained time is shorter than a second preset time when the first transient time is shorter than a first preset time, wherein the step (18) is performed when the first sustained time is longer than the second preset time; (8) determining whether the second transient time is shorter than a third preset time when the first sustained time is shorter than the second preset time, wherein, when the second transient time is longer than the third preset time, the step (18) is performed; (9) determining whether the second sustained time is shorter than a fourth preset time when the second transient time is shorter than the third preset time, wherein a step (10) is performed when the second sustained time is longer than the fourth preset time, wherein a step (11) is performed when the second sustained time is shorter than the fourth preset time; (10) determining a operation is the signal clicking instruction when the second sustained time is longer than the fourth preset time; (11) detecting a third transient time when the second sustained time is shorter than the fourth preset time; wherein the third transient time is a period from the sensing signal being at an ending of a first state in the step (5), to the sensing signal being at a beginning of a second state; (12) detecting a third sustained time, wherein the third sustained time is a period from the sensing signal being at the beginning of the second state in the step (11), to the sensing signal being at an ending of the second state, wherein the second sustained time is before the third transient time, and the third transient time is before the third sustained time; (13) determining whether the third transient time is shorter than a fifth preset time, wherein, when the third transient time is longer than the fifth preset time, the step (18) is performed; (14) determining whether the third sustained time is longer than a sixth preset time when the third transient time is shorter than the fifth preset time, wherein a step (15) is performed when the third sustained time is longer than the sixth preset time, wherein a step (16) is performed when the third sustained time is shorter than the sixth preset time; (15) determining the operation is the dragging instruction when the third sustained time is longer than the sixth preset time; (16) detecting a fourth transient time when the third sustained time is shorter than the sixth preset time, wherein the fourth transient time is a period from the sensing signal being at the ending of the second state in step (12) to the sensing signal being converted to the first state, wherein the third sustained time is before the fourth transient time; (17) determining whether the fourth transient time is shorter than a seventh preset time, wherein, when the fourth transient time is longer than the seventh preset time, the step (18) is performed; (18) outputting a false operation; and (19) determining the operation is the double clicking instruction when the fourth transient is shorter than the seventh preset time.

In the methods for identifying a single clicking, double clicking, and dragging instructions according to the preferred embodiment of the invention, the first preset time is equal to the third preset time. The third preset time is equal to the fifth preset time. The fifth preset time is equal to the seventh preset time. In another preferred embodiment of the present invention, the second preset time is equal to the sixth preset time. Also, the touch panel is a capacitive touch panel in a preferred embodiment of the present invention.

In the methods for identifying a single clicking, double clicking, and dragging instructions according to the preferred embodiment of the invention, the method further comprises the steps of: determining whether the object leaves the touch panel when the false operation is outputted; and coming back to the step (1) to continuously determine when the object left the touch panel.

To achieve the above-mentioned or other objectives, the invention further provides a method for identifying instructions, adapted for a touch panel, the method includes the steps of: (1) determining whether an object touches the touch panel, wherein a sensing signal is outputted when the object approaches the touch panel; (2) detecting a first transient time, wherein the first transient time is a period from a time when the sensing signal ends a first state, which the touch panel does not be touched, to the sensing signal is at a beginning of a second state, which the touch panel is touched; (3) detecting a first sustained time, wherein the first sustained time is a period from a time when the sensing signal is at the beginning of the second state in the step (2) to a time when the sensing signal ends the second state; (4) detecting a second transient time, wherein the second transient time is a period from a time when the sensing signal ends the second state in the step (3), to a time when the sensing signal is converted to the first state; (5) detecting a second sustained time, wherein the second sustained time is a period from a time when the sensing signal is at a beginning of the first state in step (4) to a time when the sensing signal ends the first state, wherein, when the second sustained time is longer than a determination time, the second sustained time is set to a determination time, wherein the first transient time is before the first sustained time, the first sustained time is before the second transient time, and the second transient time is before the second sustained time; (6) determining whether the first transient time is shorter than a first preset time, wherein a step (18) is performed when the first transient time is longer than the first preset time; (7) determining whether the first sustained time is shorter than a second preset time when the first transient time is shorter than a first preset time, wherein the step (18) is performed when the first sustained time is longer than the second preset time; (8) determining whether the second transient time is shorter than a third preset time when the first sustained time is shorter than the second preset time, wherein, when the second transient time is longer than the third preset time, the step (18) is performed; (9) determining whether the second sustained time is shorter than a fourth preset time when the second transient time is shorter than the third preset time, wherein a step (10) is performed when the second sustained time is longer than the fourth preset time, wherein a step (11) is performed when the second sustained time is shorter than the fourth preset time; (10) determining a operation is the signal clicking instruction when the second sustained time is longer than the fourth preset time; (11) detecting a third transient time when the second sustained time is shorter than the fourth preset time, wherein the third transient time is a period from a time when the sensing signal ends a first state in the step (5), to a time when the sensing signal is at a beginning of a second state; (12) detecting a third sustained time, wherein the third sustained time is a period from a time when the sensing signal is at the beginning of the second state in the step (11), to a time when the sensing signal ends the second state, wherein the second sustained time is before the third transient time, and the third transient time is before the third sustained time; (13) determining whether the third transient time is shorter than a fifth preset time, wherein, when the third transient time is longer than the fifth preset time, the step (18) is performed; (14) determining whether the third sustained time is longer than a sixth preset time when the third transient time is shorter than the fifth preset time, wherein a step (15) is performed when the third sustained time is longer than the sixth preset time, wherein a step (16) is performed when the third sustained time is shorter than the sixth preset time; (15) determining the operation is the dragging instruction when the third sustained time is longer than the sixth preset time; (16) detecting a fourth transient time when the third sustained time is shorter than the sixth preset time, wherein the fourth transient time is a period from a time when the sensing signal ends the second state in step (12) to a time when the sensing signal is converted to the first state, wherein the third sustained time is before the fourth transient time; (17) determining whether the fourth transient time is shorter than a seventh preset time, wherein, when the fourth transient time is longer than the seventh preset time, the step (18) is performed; (18) outputting a false operation; and (19) determining the operation is the double clicking instruction when the fourth transient is shorter than the seventh preset time.

The spirit of the invention is to add the distance judgment between the object, such as a finger, and the touch panel. The method can be used for detecting whether an object (finger) is close to the touch panel in order to predetermine. Also the present invention utilizes the movement speed between the object (finger) and the touch panel to be the criterion of the determination of the instruction. If the movement speed is too slow, the determination is failed.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this Detailed Description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 illustrates waveforms depicting a single clicking, a double clicking, and a dragging instruction according to the conventional art.

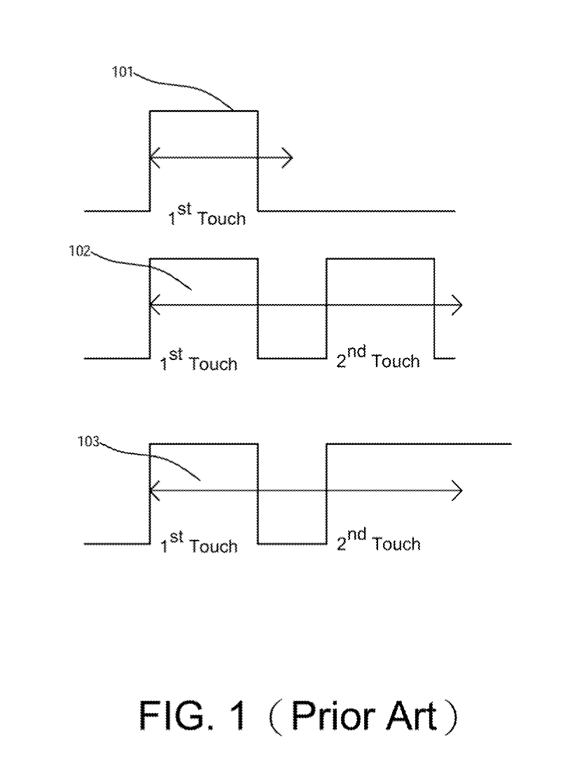

FIG. 2 illustrates a waveform depicting the method for identifying the single clicking, the double clicking, and dragging instruction according to an embodiment of the present invention.

FIG. 3 illustrates a flow chart depicting a method for identifying a single clicking instruction according to a first embodiment of the present invention.

FIG. 4 illustrates a waveform of the signal outputted from the touch panel when the single click occurs according to a first embodiment of the present invention.

FIG. 5 illustrates a flow chart depicting a method for identifying a double clicking instruction according to a second embodiment of the present invention.

FIG. 6 illustrates a waveform of the signal outputted from the touch panel when the double click occurs according to a second embodiment of the present invention.

FIG. 7 illustrates a flow chart depicting a method for identifying a dragging instruction according to a first embodiment of the present invention.

FIG. 8 illustrates a waveform of the signal outputted from the touch panel when the drag occurs according to a first embodiment of the present invention.

FIG. 9 illustrates a flow chart depicting a method for identifying instructions of the touch panel according to a second embodiment of the present invention.

### DETAILED DESCRIPTION OF THE INVENTION

The present invention will be apparent from the following detailed description, which proceeds with reference to the accompanying drawings, wherein the same references relate to the same elements.

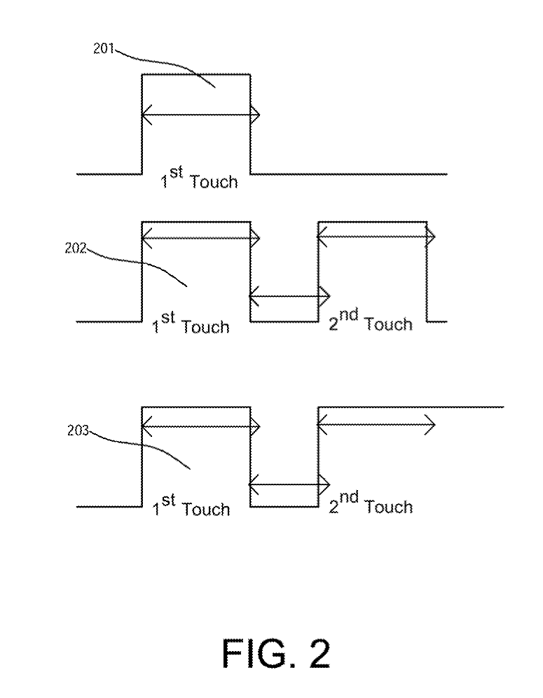

Before to describe the method for identifying a single clicking instruction, a double clicking instruction, or a dragging instruction in the present invention, another method for identifying a single clicking instruction, a double clicking instruction, or a dragging instruction would be firstly described. Referring to FIG. 2. FIG. 2 illustrates a waveform depicting the method for identifying the single clicking, the double clicking, and dragging instruction according to an embodiment of the present invention. Similarly, please referring to the waveform 201, a period, from a time when a first contact occurs, to a time when a first contact finishes, is shorter than the first preset time T1, and also, in the second preset time T2, a second contact does not occur, it is determined that this touch control is a single click.

Next, referring to the waveform 202, a period, from a time when a first contact occurs, to a time when a first contact finishes, is shorter than the first preset time T1, and the second contact occurs during the second preset time T2, and the sustained time of the second contact is shorter than the third preset time T3, it represents that this touch control is a double click.

Then referring to the waveform 203, a period, from a time when a first contact occurs, to a time when a first contact finishes, is shorter than the first preset time T1, and the second contact occurs during the second preset time T2, and the sustained time of the second contact is longer than the third preset time T3, it represents that this touch control is a drag.

In accordance with the abovementioned description, this identifying method can be distinct from the conventional art. However, when the touch panel is a capacitive touch panel, the sensing signal would vary with the finger's approach. Also, the sensing signal of the capacitive touch panel would vary in accordance with the touched area of the finger. Thus, the abovementioned method still has lower compatibility for the capacitive touch panel.

### First Embodiment

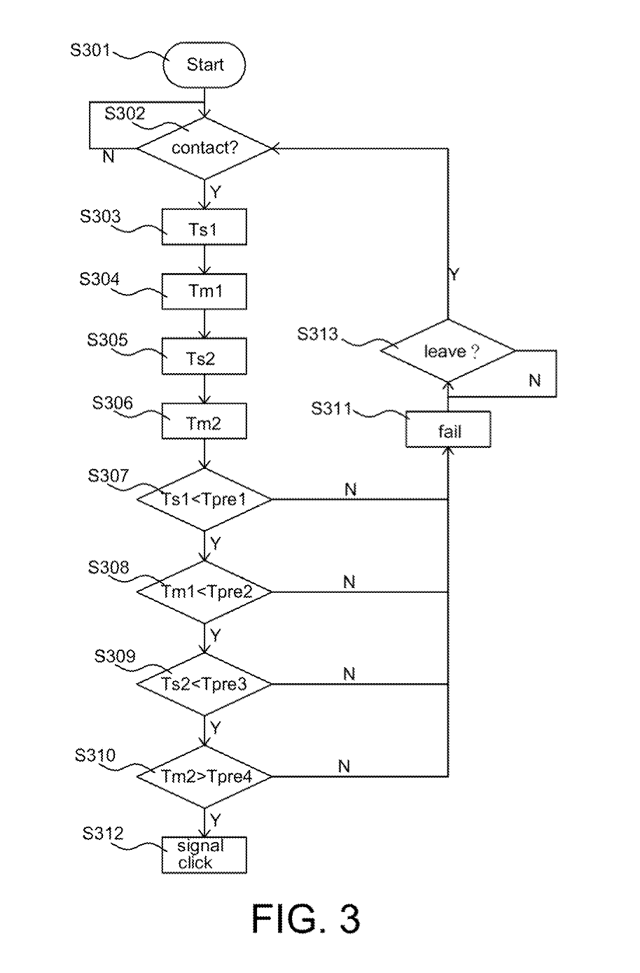

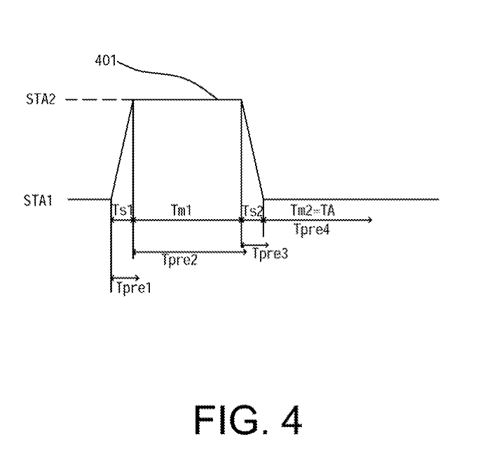

In order to increase the identification rate of the touch instructions of the capacitive touch panel, the present embodiment provides a method for identifying a single clicking instruction. FIG. 3 illustrates a flow chart depicting a method for identifying a single clicking instruction according to a first embodiment of the present invention. FIG. 4 illustrates a waveform of the signal outputted from the touch panel when the single click occurs according to a first embodiment of the present invention. Please referring to FIG. 3 and FIG. 4, the method includes the steps as follow.

In step S301, the method starts.

In step S302, it is determined whether an object will be contact with the touch panel or not. When an object will be contact with the touch panel, a sensing signal is outputted.

In step S303, a first transient time Ts1 is detected. Referring to FIG. 4, the abovementioned transient time Ts1 is a period from the sensing signal 401 being at the ending of the first state STA 1, which represents the capacitive touch panel does not be touched, to the sensing signal 401 being converted to the second state STA2, which represent the capacitive touch panel is touched. The first transient time Ts1 represents a period from a time when an object, such as a finger, starts to approach the capacitive touch panel to a time when the object totally touches the capacitive touch panel.

In step S304, a first sustained time Tm1 is detected. Referring to FIG. 4, the abovementioned first sustained time Tm1 is a period from a time when the sensing signal 401 is at the beginning of the second state STA2 in the step S303, to a time when the sensing signal 401 is at the ending of the second state STA2. The first sustained time Tm1 represents the time the object stays on the touch panel.

In the step S305, a second transient time Ts2 is detected. Referring to FIG. 4, the abovementioned second transient time Ts2 is a period from a time when the sensing signal 401 is at the ending of the second state STA2 in the step S304 to a time when the sensing signal 401 is converted to the first state STA1. The second transient time Ts2 represents that a period from a time when the object (finger) totally contacts the touch panel to a time when the object (finger) leaves the touch panel for a preset distance.

In step S306, a second sustained time Tm2 is detected. Please referring to FIG. 4, the abovementioned second sustained time Tm2 is a period from a time when the sensing signal 401 is at the beginning of the first state STA in the step S305 to the time when the sensing signal 401 is at the ending of the first state STA1 or starts to convert to the second state STA2. If the second sustained time Tm2 is longer than a preset time TA, the second sustained time would be set to the preset time TA.

In step S307, it is determined whether the first transient time Ts1 is shorter than a first preset time Tpre1. If the first transient time Ts1 is longer than the first preset time Tpre1, the step S311 is performed.

In step S308, when the first transient time Ts1 is shorter than the first preset time Tpre1, it is determined whether the first sustained time Tm1 is shorter than a second preset time Tpre2. If the first sustained time Tm1 is longer than the second preset time Tpre2, the step S311 is performed.

In step S309, when the first sustained time Tm1 is shorter than the second preset time Tpre2, it is determined whether the second transient time Ts2 is shorter than a third preset time Tpre3. If the second transient time is longer than the third preset time Tpre3, the step S311 is performed.

In step S310, when the second transient time Ts2 is shorter than the third preset time Tpre3, it is determined whether the second sustained time Tm2 is longer than a fourth preset time Tpre4. When the second sustained time Tm2 is shorter than the fourth preset time Tpre4, the step S311 is performed.

In the step S311, the operation failed.

In step S312, when the second sustained time Tm2 is longer than the fourth preset time Tpre4, it is determined that the clicking instruction is a single clicking instruction.

In step S313, it is determined whether the object leaves the touch panel. When the object leaves the touch panel, return to the step S302 for continuous determination.

In comparison with the abovementioned steps before the first embodiment, two steps for determining whether the object is approaching and whether the object is leaving in the single-clicking determination steps are added. The capacitive touch panel not only has a response when the object (finger) touched the panel, but also has a response when the object (finger) approaches the panel. Therefore, detecting the movement speed of the object (finger) can be used for determining whether the instruction is. In this case, if the movement speed of the object (finger) is too slow, it is determined “the operation failed”. Thus, the misjudgment can be prevented.

### Second Embodiment

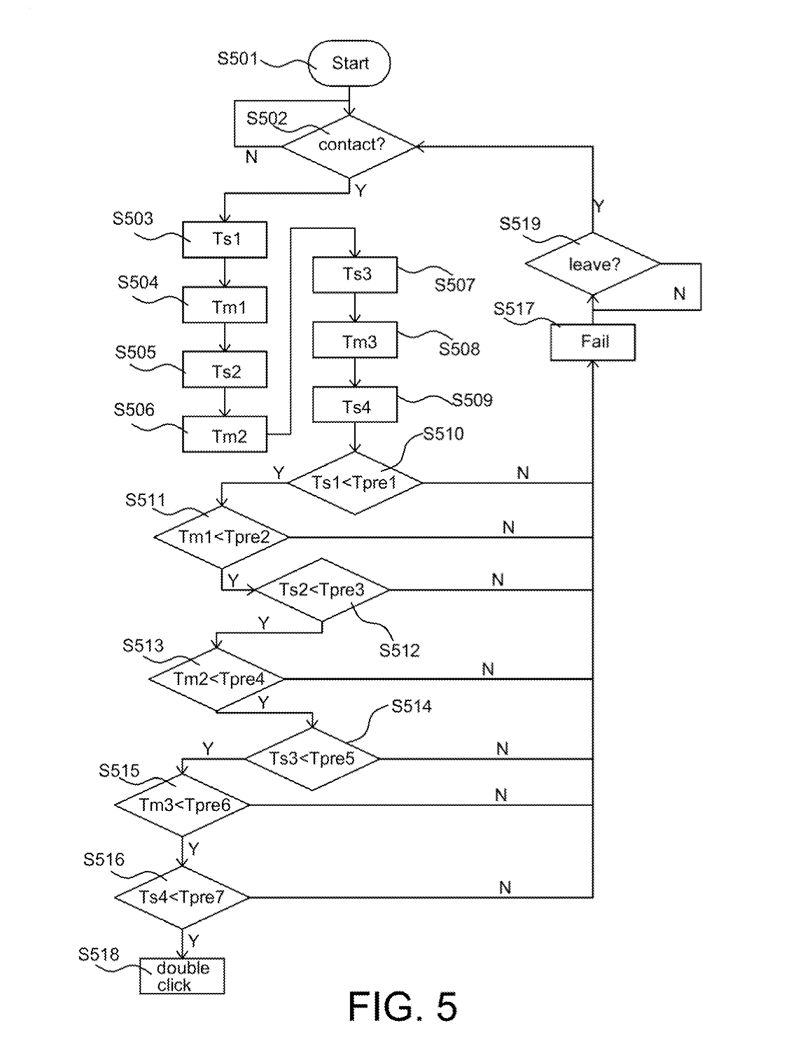

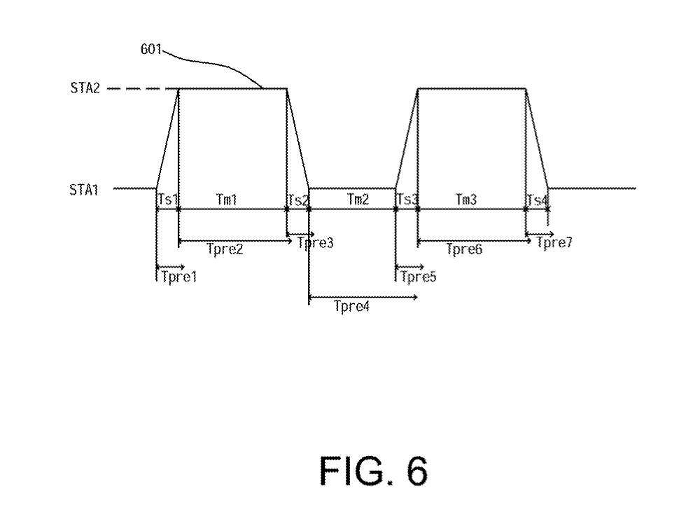

Similarly, in order to increase the recognition rate of the capacitive touch panel, the present embodiment provides a method for determining a double clicking instruction. FIG. 5 illustrates a flow chart depicting a method for identifying a double clicking instruction according to a second embodiment of the present invention. FIG. 6 illustrates a waveform of the signal outputted from the touch panel when the double click occurs according to a second embodiment of the present invention. Referring to FIG. 5 and FIG. 6, the method includes the steps of:

In steps S501, the method starts.

In steps S502, It is determined whether an object will be contact with the touch panel or not. When an object will be contact with the touch panel, a sensing signal 601 is outputted.

In step S503, a first transient time Ts1 is detected. Referring to FIG. 6, the first transient time Ts1 is a period from the time when the sensing signal 601 is in the first state STA1, where the touch panel does not be touched, to the time when the sensing signal 601 is at the beginning of the second state STA2. The first transient time Ts1 represents the period from the time when the object (especially a finger) start to be close to the capacitive touch panel to the time when the object (finger) completely touch the capacitive touch panel.

In step S504, a first sustained time Tm1 is detected. Referring to FIG. 6, the first sustained time Tm1 is a period from the time when the sensing signal 601 is at the beginning of the second state STA2 to the time when the sensing signal 601 ends the second state STA2. The first sustained time Tm1 represents the period during which the object stay at the capacitive touch panel.

In step S505, the second transient time Ts2 is detected. Referring to FIG. 6, the second transient time Ts2 is a period from the time when the sensing signal 601 ends the second state STA2 at the step S504 to the time when the sensing signal 601 becomes the first state STA1. The second transient time Ts2 represent the period from the time when the object (finger) completely touches the capacitive touch panel to the time when the object (finger) leaves the capacitive touch panel for a preset distance.

In step S506, the second sustained time Tm2 is detected. Referring to FIG. 6, the second sustained time Tm2 is a period from the time when the sensing signal 601 is at the beginning of the first state STA1 in step S505 to the time when the sensing signal 601 ends the first state STA1. The second sustained time Tm2 represents the period from the time when the object completely leaves the capacitive touch panel to the time when the object (finger) start to be close to the capacitive touch panel.

In step S507, the third transient time Ts3 is detected. Referring to FIG. 6, the third transient time Ts3 is the period from the time when the sensing signal 601 ends the first state STA1 in the step S506 to the time when the sensing signal 601 is at the beginning of the second state STA2. The third transient time Ts3 represents the period from the time when the object (finger) is once more close to the capacitive touch panel to the time when the object (finger) completely touches the capacitive panel.

In step S508, the third sustained time Tm3 is detected. The third sustained time Tm3 is the period from the time when the sensing signal 601 at the beginning of the second state STA2 in the step S507 to the time when the sensing signal 601 ends the second state STA2. The third sustained time Tm3 represents the period during which the object (finger) touches the capacitive touch panel.

In step S509, the fourth transient time Ts4 is detected. The fourth transient time Ts4 is the period from the time when the sensing signal 601 ends the second state STA2 in the step S508 to the time when the sensing signal 601 converts to the first state STA1. The fourth transient time Ts4 represents the period from the time when the object completely touches the capacitive touch panel to the time when the object leaves the capacitive touch panel.

In step S510, it is determined whether the first transient time Ts1 is shorter than the first preset time Tpre1. When the first transient time Ts1 is longer than the first preset time Tpre1, the step S517 is performed.

In step S511, it is determined whether the first sustained time Tm1 is shorter than the second preset time Tpre2 when the first transient time Ts1 is shorter than the first preset time Tpre1. When the first sustained time Tm1 is longer than the second preset time Tpre2, the step S517 is performed.

In step S512, it is determined whether the second transient time Ts2 is shorter than the third preset time Tpre3 when the first sustained time Tm1 is shorter than the second preset time Tpre2. When the second transient time Ts2 is longer than the third preset time Tpre3, the step S517 is performed.

In step S513, it is determined whether the second sustained time Tm2 is shorter than the fourth preset time Tpre4 when the second transient time Ts2 is shorter than the third preset time Tpre3. When the second sustained time Tm2 is longer than the fourth preset time Tpre4, the step S517 is performed.

In step S514, It is determined whether the third transient time Ts3 is shorter than the fifth preset time Tpre5 when the second sustained time Tm2 is shorter than the fourth preset time Tpre4. When the third transient time Ts3 is longer than the fifth preset time Tpre5, the step S517 is performed.

In step S515, It is determined whether the third sustained time Tm3 is shorter than the sixth preset time Tpre6 when the third transient time Ts3 is shorter than the fifth preset time Tpre5. When the third sustained time Tm3 is longer than the sixth preset time, the step S517 is performed.

In step S516, It is determined whether the fourth transient time Ts4 is shorter than the seventh preset time Tpre7 when the third sustained time Tm3 is shorter than the sixth preset time Tpre6. When the fourth transient time Ts4 is longer than the seventh preset time Tpre7, the step S517 is performed.

In step S517, the operation failed.

In step S518, it is determined that the click instruction is a double click instruction when the fourth transient time Ts4 is shorter than the seventh preset time Tpre7.

In step S519, it is determined whether the object leaves the touch panel. When the object leaves the touch panel, return to the step S502 to continue the method.

Similar to the abovementioned first embodiment, the double click determination step of this embodiment adds the determination steps of the object approaching and the object leaving. Since the capacitive touch panel not only has a response when the object touches the capacitive touch panel, but also has a response when the object approaches the capacitive touch panel. Thus, detecting the movement speed of the object (finger) can be used for determining whether the instruction is. In this case, if the movement speed of the object (finger) is too slow, it is determined “the operation failed”. Therefore, the misjudgment can be prevented.

### Third Embodiment

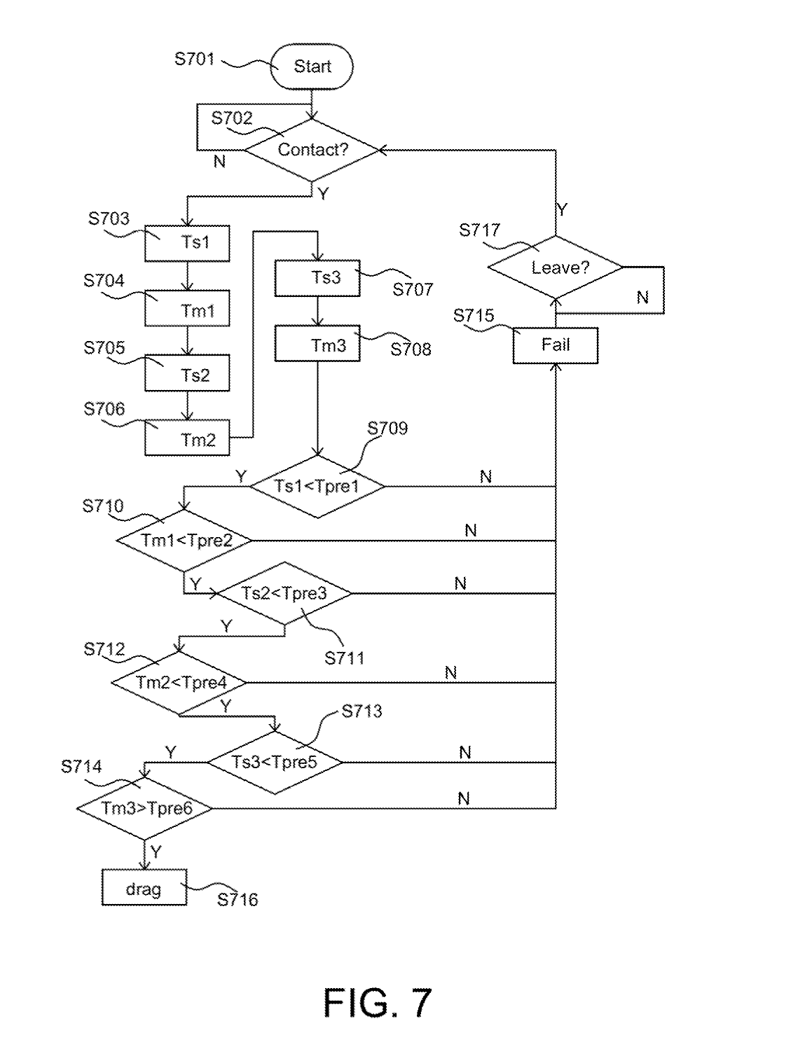

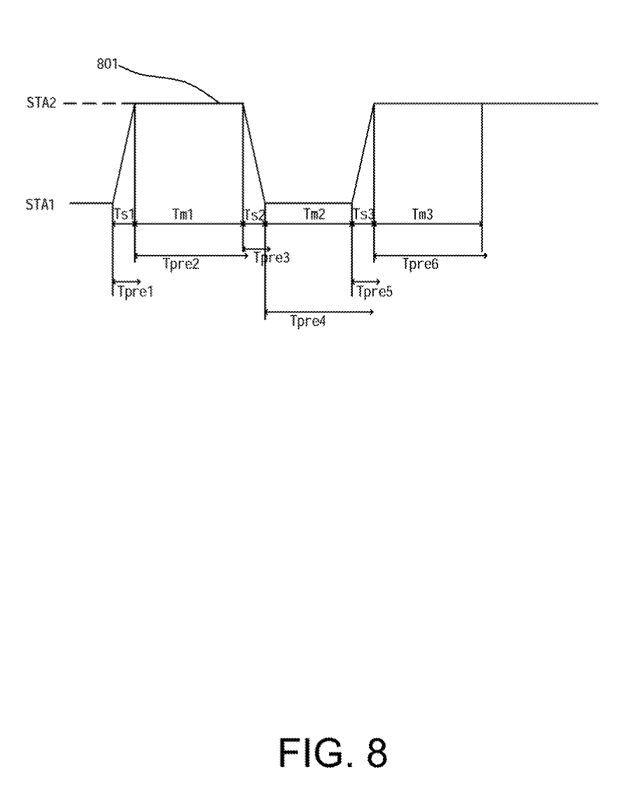

Similarly, in order to increase the instruction recognition rate of the capacitive touch panel, the present embodiment provides a method for identifying the dragging instruction. FIG. 7 illustrates a flow chart depicting a method for identifying a dragging instruction according to a first embodiment of the present invention. FIG. 8 illustrates a waveform of the signal outputted from the touch panel when the drag occurs according to a first embodiment of the present invention. Please referring to FIG. 7 and FIG. 8, the method includes the steps of:

In step S701, the method starts.

In step S702, It is determined whether an object will be contact with the touch panel or not. When an object will be contact with the touch panel, a sensing signal 801 is outputted.

In step S703, a first transient time Ts1 is detected. Referring to FIG. 8, the first transient time is the period from the time when the sensing signal 801 ends the first state STA1, which the touch panel does not be contacted, to the time when the sensing signal 801 is at the beginning of the second state STA2, which the touch panel is contacted.

In step S704, a first sustained time Tm1 is detected. Referring to FIG. 8, the first sustained time Tm1 is a period from the time when the sensing signal 801 is at the beginning of the second state STA2 in step S703 to the time when the sensing signal 801 ends the second state STA2.

In step S705, the second transient time Ts2 is detected. Referring to FIG. 8, the second transient time Ts2 is a period from the time when the sensing signal 801 ends the second state STA2 in step S704 to the time when the sensing signal 801 is converted to the first state STA1.

In step S706, the second sustained time Tm2 is detected. Referring to FIG. 8, the second sustained time Tm2 is a period from the time when the sensing signal 801 is at the beginning of the first state STA1 in step S705 to the time when the sensing signal 801 ends the first state STA1.

In step S707, the third transient time Ts3 is detected. Referring to FIG. 8, the third transient time is a period from the time when the sensing signal 801 ends the first state STA1 in step S706 to the time when the sensing signal 801 is converted to the second state STA2.

In step S708, the third sustained time Tm3 is detected. Referring to FIG. 8, the third sustained time Tm3 is a period from the time when the sensing signal 801 is at the beginning of the second state STA2 in step S707 to the time when the sensing signal 801 ends the second state STA2.

In step S709, it is determined whether the first transient time Ts1 is shorter than the first preset time Tpre1. When the first transient time Ts1 is longer than the first preset time Tpre1, the step S715 is performed.

In step S710, it is determined whether the first sustained time Tm1 is shorter than the second preset time Tpre2 when the first transient time Ts1 is shorter than the first preset time Tpre1. When the first sustained time Tm1 is longer than the second preset time Tpre2, the step S715 is performed.

In step S711, it is determined whether the second transient time Ts2 is shorter than the third preset time Tpre3 when the first sustained time Tm1 is shorter than the second preset time Tpre2. When the second transient time Ts2 is longer than the third preset time Tpre3, the step S715 is performed.

In step S712, it is determined whether the second sustained time Tm2 is shorter than the fourth preset time Tpre4 when the second transient time Ts2 is shorter than the third preset time Tpre3. When the second sustained time Tm2 is longer than the fourth preset time Tpre4, the step S715 is performed.

In step S713, It is determined whether the third transient time Ts3 is shorter than the fifth preset time Tpre5 when the second sustained time Tm2 is shorter than the fourth preset time Tpre4. When the third transient time Ts3 is longer than the fifth preset time Tpre5, the step S715 is performed.

In step S714, It is determined whether the third sustained time Tm3 is longer than the sixth preset time Tpre6 when the third transient time Ts3 is shorter than the fifth preset time Tpre5. When the third sustained time Tm3 is smaller than the sixth preset time Tpre6, the step S715 is performed.

In step S715, the operation failed.

In step S716, It is determined the inputted instruction is the dragging instruction when the third sustained time Tm3 is longer than the sixth preset time Tpre6. The third sustained time Tm3 represents a period from the time when the second time the object completely touches the capacitive touch panel to the time when the object leaves the capacitive touch panel. When the time Tm3 is longer than the sixth preset time Tpre6, it represents that the dragging instruction is performed.

In step S717, it is determined whether the object leaves the touch panel or not. When the object leaves the touch panel, return to the step S702 to continue the method.

Similar to the abovementioned two embodiments, when the method for identifying dragging instruction adds the determination steps of the object approaching and the object leaving. Since the capacitive touch panel not only has a response when the object touches the capacitive touch panel, but also has a response when the object approaches the capacitive touch panel. Thus, detecting the movement speed of the object (finger) can be used for determining whether the instruction is. In this case, if the movement speed of the object (finger) is too slow, it is determined “the operation failed”. Therefore, the misjudgment can be prevented.

### Fourth Embodiment

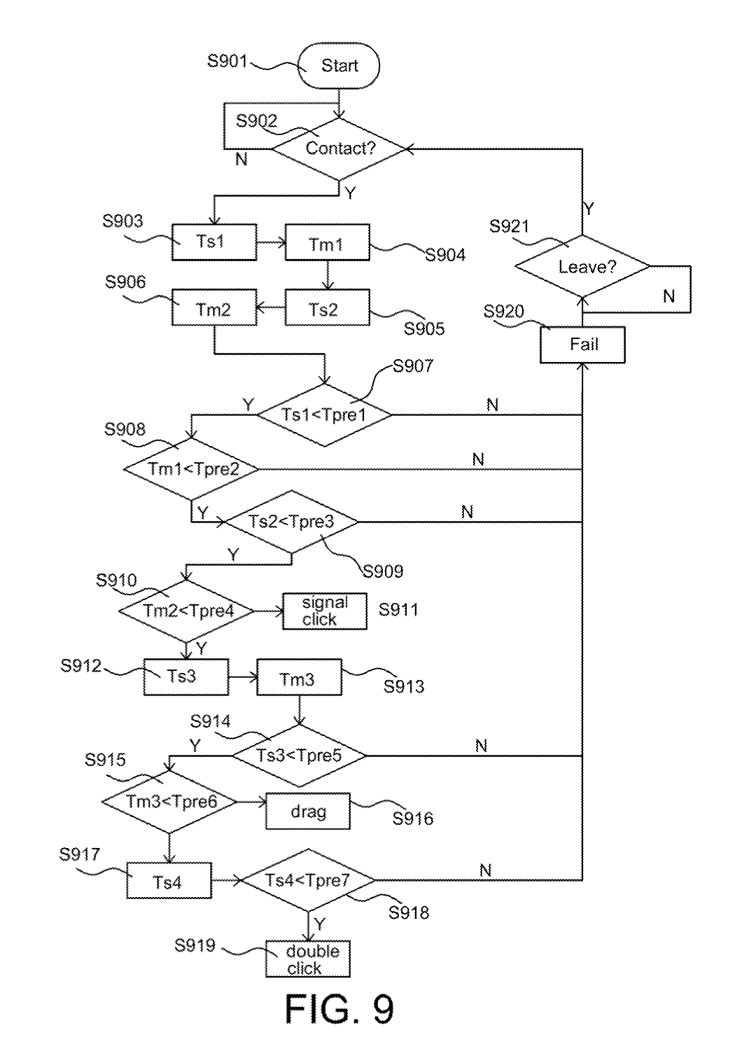

In accordance with the three embodiments, they can be concluded as a method for identifying the instructions. Referring to FIG. 9, FIG. 9 illustrates a flow chart depicting a method for identifying instructions of the touch panel according to a second embodiment of the present invention. The method includes the steps of:

In step S901, the method starts.

In step S902, it is determined whether an object will be contact with the touch panel or not. When an object will be contact with the touch panel, a sensing signal is outputted.

In step S903, the first transient time Ts1 is detected. Referring to the label Ts1 in FIG. 4, FIG. 6 and FIG. 8, the first transient time Ts1 is the period from the time when the sensing signal ends the first state STA1, which the touch panel does not be approached, to the time when the sensing signal is at the beginning of the second state STA2, which the touch panel is touched.

In step S904, the first sustained time Tm1 is detected. Referring to the label Tm1 in FIG. 4, FIG. 6 and FIG. 8, the first sustained time Tm1 is the period from the time when the sensing signal is at the beginning of the second state STA2 in step S903 to the time when the sensing signal ends the second state STA2.

In step S905, the second transient time Ts2 is detected. Referring to the label Ts2 in FIG. 4, FIG. 6 and FIG. 8, the second transient time Ts2 is the period from the time when the sensing signal ends the second state STA2 in step S904 to the time when the sensing signal is converted to the first state STA1.

In step S906, the second sustained time Tm2 is detected. Referring to the label Tm2 in FIG. 4, FIG. 6 and FIG. 8, the second sustained time Tm2 is the period from the time when the sensing signal is at the beginning of the first state STA1 in step S905 to the time when the sensing signal ends the first state STA1. In accordance with FIG. 4, FIG. 6 and FIG. 8, it can be seen that the second sustained time Tm2 is the key to identify the signal clicking instruction, the double clicking instruction and the dragging instruction. Thus, if the second sustained time Tm2 is sufficiently long, we can determine that the operation is a signal click.

In step S907, it is determined whether the first transient time Ts1 is shorter than a first preset time Tpre1. If the first transient time Ts1 is longer than the first preset time Tpre1, the step S919 is performed.

In step S908, when the first transient time Ts1 is shorter than the first preset time Tpre1, it is determined whether the first sustained time Tm1 is shorter than a second preset time Tpre2. If the first sustained time Tm1 is longer than the second preset time Tpre2, the step S919 is performed.

In step S909, when the first sustained time Tm1 is shorter than the second preset time Tpre2, it is determined whether the second transient time Ts2 is shorter than a third preset time Tpre3. If the second transient time is longer than the third preset time Tpre3, the step S919 is performed.

In step S910, when the second transient time Ts2 is shorter than the third preset time Tpre3, it is determined whether the second sustained time Tm2 is longer than a fourth preset time Tpre4. When the second sustained time Tm2 is shorter than the fourth preset time Tpre4, the step S912 is performed.

In step S911, when the second sustained time Tm2 is longer than the fourth preset time Tpre4, it is determined that the operation is a single clicking instruction.

In step S912, when the second sustained time Tm2 is shorter than the fourth preset time Tpre4, the third transient time Ts3 is detected. Referring to the label Ts3 in FIG. 6 and FIG. 8, the third transient time Ts3 is the period from the time when the sensing signal ends the first state STA1 in step S906 to the time when the sensing signal is converted to the second step STA2.

In step S913, the third sustained time Tm3 is detected. Referring to FIG. 6 and FIG. 8, the third sustained time Tm3 is the period from the time when the sensing signal is at the beginning of the second state STA2 in step S912 to the time when the sensing signal ends the second state STA2. Similar to the foregoing reason, as shown in FIG. 6 and FIG. 8, the key to identify the double clicking instruction or the dragging instruction is whether the third sustained time is sufficiently long or not. Thus, if the third sustained time is sufficiently long, we can determine that the operation is a drag.

In step S914, It is determined whether the third transient time Ts3 is shorter than the fifth preset time Tpre5 when the second sustained time Tm2 is shorter than the fourth preset time Tpre4. When the third transient time Ts3 is longer than the fifth preset time Tpre5, the step S919 is performed.

In step S915, It is determined whether the third sustained time Tm3 is shorter than the sixth preset time Tpre6 when the third transient time Ts3 is shorter than the fifth preset time Tpre5. When the third sustained time Tm3 is longer than the sixth preset time Tpre6, the step S916 is performed. When the third sustained time Tm3 is shorter than the sixth preset time Tpre6, the step S917 is performed.

In step S916, it is determined that the operation is the dragging instruction when the third sustained time Tm3 is longer than the sixth preset time Tpre6.

In step S917, the fourth transient time Ts4 is detected when the third sustained time Tm3 is shorter than the sixth preset time Tpre6. Referring to FIG. 6, the fourth transient time Ts4 is the period from the time when the sensing signal ends the second state STA2 in step S913 to the time when the sensing signal is converted to the first state STA1.

In step S918, It is determined whether the fourth transient time Ts4 is shorter than the seventh preset time Tpre7. When the fourth transient time Ts4 is longer than the seventh preset time Tpre7, the step S919 is performed.

In step S919, the operation failed.

In step S920, when the fourth transient time Ts4 is shorter than the seventh preset time Tpre7,

In step S921, when the operation is failed, it is determined whether the object leaves the touch panel or not. When the object leaves the touch panel, return to the step S902.

In summary, the spirit of the invention is to add the distance judgment between the object, such as a finger, and the touch panel. The method can be used for detecting whether an object (finger) is close to the touch panel in order to predetermine. Also the present invention utilizes the movement speed between the object (finger) and the touch panel to be the criterion of the determination of the instruction. If the movement speed is too slow, the determination is failed.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A method for identifying a single clicking instruction, adapted for a touch panel, comprising:
(1) outputting a sensing signal when an object approaches the touch panel;
(2) detecting a first transient time, wherein the first transient time is a period from a time when the sensing signal is at an ending of a first state, which the touch panel does not be touched, to a time when the sensing signal is at a beginning of a second state, which the touch panel is touched;
(3) detecting a first sustained time, wherein the first sustained time is a period from a time when the sensing signal is at the beginning of the second state in the step (2) to a time when the sensing signal ends of the second state;
(4) detecting a second transient time, wherein the second transient time is a period from a time when the sensing signal ends the second state, to a time when the sensing signal is converted to the first state;
(5) detecting a second sustained time, wherein the second sustained time is a period from a time when the sensing signal is at a beginning of the first state in step (4) to a time when the sensing signal ends the first state, wherein, when the second sustained time is longer than a determination time, the second sustained time is set to a determination time, wherein the first transient time is before the first sustained time, the first sustained time is before the second transient time, and the second transient time is before the second sustained time;
(6) determining whether the first transient time is shorter than a first preset time, wherein a step (10) is performed when the first transient time is longer than the first preset time;
(7) determining whether the first sustained time is shorter than a second preset time when the first transient time is shorter than a first preset time, wherein the step (10) is performed when the first sustained time is longer than the second preset time;
(8) determining whether the second transient time is shorter than a third preset time when the first sustained time is shorter than the second preset time, wherein, when the second transient time is longer than the third preset time, the step (10) is performed;
(9) determining whether the second sustained time is longer than a fourth preset time when the second transient time is shorter than the third preset time, wherein the step (10) is performed when the second sustained time is shorter than the fourth preset time;
(10) outputting a false operation; and
(11) determining a operation is the signal clicking instruction when the second sustained time is longer than the fourth preset time.

2. The method for identifying a single clicking instruction according to claim 1, wherein the first preset time is equal to the third preset time.

3. The method for identifying a single clicking instruction according to claim 1, wherein the touch panel is a capacitive touch panel.

4. The method for identifying a single clicking instruction according to claim 1, further comprising:
determining whether the object leaves the touch panel when the false operation is outputted; and
coming back to the step (1) to continuously determine when the object left the touch panel.

5. A method for identifying a double clicking instruction, adapted for a touch panel, comprising:
(1) determining whether an object touches the touch panel, wherein a sensing signal is outputted when the object approaches the touch panel;
(2) detecting a first transient time, wherein the first transient time is a period from a time when the sensing signal ends a first state, which the touch panel does not be touched, to a time when the sensing signal is at a beginning of a second state, which the touch panel is touched;
(3) detecting a first sustained time, wherein the first sustained time is a period from a time when the sensing signal is at the beginning of the second state in the step (2) to a time when the sensing signal ends the second state;
(4) detecting a second transient time, wherein the second transient time is a period from a time when the sensing signal ends the second state in the step (3), to a time when the sensing signal is converted to the first state;
(5) detecting a second sustained time, wherein the second sustained time is a period from a time when the sensing signal is at a beginning of the first state in step (4) to a time when the sensing signal ends the first state, wherein, when the second sustained time is longer than a determination time, the second sustained time is set to a determination time;
(6) detecting a third transient time, wherein the third transient time is a period from a time when the sensing signal ends a first state in the step (5), to a time when the sensing signal is at a beginning of a second state;
(7) detecting a third sustained time, wherein the third sustained time is a period from a time when the sensing signal is at the beginning of the second state in the step (6), to a time when the sensing signal ends the second state;
(8) detecting a fourth transient time, wherein the fourth transient time is a period from a time when the sensing signal ends the second state in step (7) to a time when the sensing signal is converted to the first state, wherein the first transient time is before the first sustained time, the first sustained time is before the second transient time, the second transient time is before the second sustained time, the second sustained time is before the third transient time, the third transient time is before the third sustained time, and the third sustained time is before the fourth transient time;
(9) determining whether the first transient time is shorter than a first preset time, wherein a step (16) is performed when the first transient time is longer than the first preset time;
(10) determining whether the first sustained time is shorter than a second preset time when the first transient time is shorter than a first preset time, wherein the step (16) is performed when the first sustained time is longer than the second preset time;
(11) determining whether the second transient time is shorter than a third preset time when the first sustained time is shorter than the second preset time, wherein, when the second transient time is longer than the third preset time, the step (16) is performed;
(12) determining whether the second sustained time is shorter than a fourth preset time when the second transient time is shorter than the third preset time, wherein the step (16) is performed when the second sustained time is longer than the fourth preset time;
(13) determining whether the third transient time is shorter than a fifth preset time when the second sustained time is shorter than the fourth preset time, wherein, when the third transient time is longer than the fifth preset time, the step (16) is performed;
(14) determining whether the third sustained time is shorter than a sixth preset time when the third transient time is shorter than the fifth preset time, wherein the step (16) is performed when the third sustained time is longer than the sixth preset time;
(15) determining whether the fourth transient time is shorter than a seventh preset time when the third sustained time is shorter than the sixth preset time, wherein, when the fourth transient time is longer than the seventh preset time, the step (16) is performed;
(16) outputting a false operation; and
(17) determining an operation is the double clicking instruction when the fourth transient is shorter than the seventh preset time.

6. The method for identifying a double clicking instruction according to claim 5, wherein the first preset time, the third preset time, the fifth preset time and the seventh preset time are equal to each other.

7. The method for identifying a double clicking instruction according to claim 5, wherein the second preset time is equal to the sixth preset time.

8. The method for identifying a double clicking instruction according to claim 5, wherein the touch panel is a capacitive touch panel.

9. The method for identifying a double clicking instruction according to claim 5, further comprising:
determining whether the object leaves the touch panel when the false operation is outputted; and
coming back to the step (1) to continuously determine when the object left the touch panel.

10. A method for identifying a dragging instruction, adapted for a touch panel, comprising:
(1) determining whether an object touches the touch panel, wherein a sensing signal is outputted when the object approaches the touch panel;
(2) detecting a first transient time, wherein the first transient time is a period from a time when the sensing signal ends a first state, which the touch panel does not be touched, to a time when the sensing signal is at a beginning of a second state, which the touch panel is touched;
(3) detecting a first sustained time, wherein the first sustained time is a period from the sensing signal being at the beginning of the second state in the step (2) to the sensing signal being at an ending of the second state;
(4) detecting a second transient time, wherein the second transient time is a period from a time when the sensing signal ends the second state in the step (3), to a time when the sensing signal is converted to the first state;
(5) detecting a second sustained time, wherein the second sustained time is a period from a time when the sensing signal is at a beginning of the first state in step (4) to the sensing signal ends the first state, wherein, when the second sustained time is longer than a determination time, the second sustained time is set to a determination time;
(6) detecting a third transient time, wherein the third transient time is a period from the sensing signal being at an ending of a first state in the step (5), to the sensing signal being at a beginning of a second state;
(7) detecting a third sustained time, wherein the third sustained time is a period from a time when the sensing signal is at the beginning of the second state in the step (6), to a time when the sensing signal ends the second state, wherein the first transient time is before the first sustained time, the first sustained time is before the second transient time, the second transient time is before the second sustained time, the second sustained time is before the third transient time, and the third transient time is before the third sustained time;
(8) determining whether the first transient time is shorter than a first preset time, wherein a step (14) is performed when the first transient time is longer than the first preset time;
(9) determining whether the first sustained time is shorter than a second preset time when the first transient time is shorter than a first preset time, wherein the step (14) is performed when the first sustained time is longer than the second preset time;
(10) determining whether the second transient time is shorter than a third preset time when the first sustained time is shorter than the second preset time, wherein, when the second transient time is longer than the third preset time, the step (14) is performed;
(11) determining whether the second sustained time is shorter than a fourth preset time when the second transient time is shorter than the third preset time, wherein the step (14) is performed when the second sustained time is longer than the fourth preset time;
(12) determining whether the third transient time is shorter than a fifth preset time when the second sustained time is shorter than the fourth preset time, wherein, when the third transient time is longer than the fifth preset time, the step (14) is performed;
(13) determining whether the third sustained time is longer than a sixth preset time when the third transient time is shorter than the fifth preset time, wherein the step (14) is performed when the third sustained time is shorter than the sixth preset time;
(14) outputting a false operation; and
(15) determining an operation is the dragging instruction when the third sustained time is longer than the sixth preset time.

11. The method for identifying a dragging instruction according to claim 10, wherein the first preset time, the third preset time, the fifth preset time and the seventh preset time are equal to each other.

12. The method for identifying a dragging instruction according to claim 10, wherein the second preset time is equal to the sixth preset time.

13. The method for identifying a dragging instruction according to claim 10, wherein the touch panel is a capacitive touch panel.

14. The method for identifying a dragging instruction according to claim 10, further comprising:
determining whether the object leaves the touch panel when the false operation is outputted; and
coming back to the step (1) to continuously determine when the object left the touch panel.

15. A method for identifying instructions, adapted for a touch panel, comprising:
(1) determining whether an object touches the touch panel, wherein a sensing signal is outputted when the object approaches the touch panel;
(2) detecting a first transient time, wherein the first transient time is a period from a time when the sensing signal ends a first state, which the touch panel does not be touched, to the sensing signal is at a beginning of a second state, which the touch panel is touched;
(3) detecting a first sustained time, wherein the first sustained time is a period from a time when the sensing signal is at the beginning of the second state in the step (2) to a time when the sensing signal ends the second state;
(4) detecting a second transient time, wherein the second transient time is a period from a time when the sensing signal ends the second state in the step (3), to a time when the sensing signal is converted to the first state;
(5) detecting a second sustained time, wherein the second sustained time is a period from a time when the sensing signal is at a beginning of the first state in step (4) to a time when the sensing signal ends the first state, wherein, when the second sustained time is longer than a determination time, the second sustained time is set to a determination time, wherein the first transient time is before the first sustained time, the first sustained time is before the second transient time, and the second transient time is before the second sustained time;
(6) determining whether the first transient time is shorter than a first preset time, wherein a step (18) is performed when the first transient time is longer than the first preset time;
(7) determining whether the first sustained time is shorter than a second preset time when the first transient time is shorter than a first preset time, wherein the step (18) is performed when the first sustained time is longer than the second preset time;
(8) determining whether the second transient time is shorter than a third preset time when the first sustained time is shorter than the second preset time, wherein, when the second transient time is longer than the third preset time, the step (18) is performed;
(9) determining whether the second sustained time is shorter than a fourth preset time when the second transient time is shorter than the third preset time, wherein a step (10) is performed when the second sustained time is longer than the fourth preset time, wherein a step (11) is performed when the second sustained time is shorter than the fourth preset time;
(10) determining a operation is the signal clicking instruction when the second sustained time is longer than the fourth preset time;
(11) detecting a third transient time when the second sustained time is shorter than the fourth preset time, wherein the third transient time is a period from a time when the sensing signal ends a first state in the step (5), to a time when the sensing signal is at a beginning of a second state;
(12) detecting a third sustained time, wherein the third sustained time is a period from a time when the sensing signal is at the beginning of the second state in the step (11), to a time when the sensing signal ends the second state, wherein the second sustained time is before the third transient time, and the third transient time is before the third sustained time;
(13) determining whether the third transient time is shorter than a fifth preset time, wherein, when the third transient time is longer than the fifth preset time, the step (18) is performed;
(14) determining whether the third sustained time is longer than a sixth preset time when the third transient time is shorter than the fifth preset time, wherein a step (15) is performed when the third sustained time is longer than the sixth preset time, wherein a step (16) is performed when the third sustained time is shorter than the sixth preset time;
(15) determining the operation is the dragging instruction when the third sustained time is longer than the sixth preset time;
(16) detecting a fourth transient time when the third sustained time is shorter than the sixth preset time, wherein the fourth transient time is a period from a time when the sensing signal ends the second state in step (12) to a time when the sensing signal is converted to the first state, wherein the third sustained time is before the fourth transient time;
(17) determining whether the fourth transient time is shorter than a seventh preset time, wherein, when the fourth transient time is longer than the seventh preset time, the step (18) is performed;
(18) outputting a false operation; and
(19) determining the operation is the double clicking instruction when the fourth transient is shorter than the seventh preset time.

16. The method for identifying instructions according to claim 15, wherein the first preset time, the third preset time, the fifth preset time and the seventh preset time are equal to each other.

17. The method for identifying instructions according to claim 15, wherein the second preset time is equal to the sixth preset time.

18. The method for identifying instructions according to claim 15, wherein the touch panel is a capacitive touch panel.

19. The method for identifying instructions according to claim 15, further comprising:
determining whether the object leaves the touch panel when the false operation is outputted; and
coming back to the step (1) to continuously determine when the object left the touch panel.
